(19) United States
(12) Patent Application Publication
(10) Pub. No.: US 2019/0155283 A1
(43) Pub. Date: May 23, 2019

(54) DETERMINING PULLOVER LOCATIONS FOR AUTONOMOUS VEHICLES

(71) Applicant: Waymo LLC, Mountain View, CA (US)

(72) Inventors: Joshua Seth Herbach, San Francisco, CA (US); Guillaume Dupre, San Francisco, CA (US)

(21) Appl. No.: 15/816,106

(22) Filed: Nov. 17, 2017

(51) Int. Cl. G05D 1/00; G01C 21/34

(52) U.S. Cl. CPC G05D 1/0088; G01C 21/3461

(57) ABSTRACT

Aspects of the disclosure relate to maneuvering a vehicle in an autonomous driving mode. For instance, that the vehicle needs to pullover may be determined based on a first input. A severity level corresponding to the first input may be determined. A set of requirements may be determined based on the severity level. A search may be performed over a map to identify a location for the vehicle to pull over that meets the set of requirements. The vehicle may then be maneuvered to pull over at the location.

### BACKGROUND

Autonomous vehicles, such as vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location.

### BRIEF SUMMARY

One aspect of the disclosure provides a method of maneuvering a vehicle in an autonomous driving mode. The method includes determining, by one or more processors, that the vehicle needs to pullover based on a first input; identifying, by the one or more processors, a severity level corresponding to the first input; identifying, by the one or more processors, a set of requirements based on the severity level; performing, by the one or more processors, a search over a map to identify a location for the vehicle to pull over that meets the set of requirements; and maneuvering, by the one or more processors, the vehicle in order to pull over at the location.

In one example, the first input is an input from a passenger of the vehicle, and the method also includes identifying a first severity level based on the input and increasing the first severity level to the severity level based on circumstances of the input. In this example, the circumstances include a number of times the passenger has used a button to generate the input. In addition or alternatively, the circumstances include an amount of force the passenger has used a button to generate the input. In addition or alternatively, the circumstances include audio or video information of the passenger. In another example, the first input is a message received from a remote computing device, and identifying the severity level is based on content of the message identifying why the vehicle needs to be pulled over. In another example, the first input is a message received from a remote system, and wherein the message identifies the severity level. In this example, the message further identifies an additional requirement, and wherein performing the search to identify the location further includes confirming that the location meets the additional requirement. In another example, the first input is a report from a system of the vehicle indicating a fault at that system, and the method also includes identifying an additional requirement based on a type of the fault. In this example, performing the search to identify the location also includes confirming that the location meets the additional requirement. In another example, the set of requirements identifies a number of permissible lane changes. In another example, the set of requirements identifies a number of permissible turns. In another example, the set of requirements identifies whether the vehicle may stop in an intersection. In another example, performing the search includes requiring that the vehicle continue along a current route for a predetermined period of time before the vehicle reaches the location. In another example, the method also includes performing the search for a predetermined period of time, such that if the location is not identified during the predetermined period of time, repeating the search using an adjusted set of requirements to identify the location. In another example, performing the search to identify the location is based on whether the vehicle will reach a destination location before reaching any location that meets the set of requirements. In this example, when the vehicle will reach the destination location before reaching any location that meets the set of requirements, setting the destination location as the location such that the vehicle continues to the destination location.

Another aspect of the disclosure provides a system for maneuvering a vehicle in an autonomous driving mode. The system includes one or more processors configured to determine that the vehicle needs to pullover based on a first input; identify a severity level corresponding to the first input; identify a set of requirements based on the severity level; perform a search over a map to identify a location for the vehicle to pull over that meets the set of requirements; and maneuver the vehicle in order to pull over at the location.

In one example, the first input is an input from a passenger of the vehicle, and the one or more processors are also configured to identify a first severity level based on the input and increase the first severity level to the severity level based on circumstances of the input. In another example, the first input is a message received from a remote computing device, and the one or more processors are also configured to identify the severity level based on content of the message identifying why the vehicle needs to be pulled over. In another example, the system also includes the vehicle.

### BRIEF DESCRIPTION OF THE DRAWINGS

FIG. 1 is a functional diagram of an example vehicle in accordance with an exemplary embodiment.

FIG. 2 is a functional diagram of an example system in accordance with an exemplary embodiment.

FIG. 3 is a pictorial diagram of the system of FIG. 2 in accordance with aspects of the disclosure.

FIGS. 4A-4D are example external views of a vehicle in accordance with aspects of the disclosure.

FIG. 4E is an example external views of a vehicle in accordance with aspects of the disclosure.

FIG. 5 is an example internal view of a vehicle in accordance with aspects of the disclosure.

FIG. 6 is an example of a console of a vehicle in accordance with aspects of the disclosure.

FIG. 7 is an example of states of a button in accordance with aspects of the disclosure.

FIG. 8 is an example of another console of a vehicle in accordance with aspects of the disclosure.

FIG. 9 is an example table in accordance with aspects of the disclosure.

FIG. 10 is another example table in accordance with aspects of the disclosure.

FIG. 11 is an example map in accordance with aspects of the disclosure.

FIG. 12 is an example bird's eye view of a geographic area in accordance with aspects of the disclosure.

FIG. 13 is an example bird's eye view of a geographic area and data in accordance with aspects of the disclosure.

FIG. 14 is a flow diagram in accordance with aspects of the disclosure.

### DETAILED DESCRIPTION

### Overview

The technology relates to determining a pullover location for an autonomous vehicle or a vehicle operating in an autonomous driving mode. Once the vehicle's computing devices determine that the vehicle needs to pullover, the computing devices may determine a severity level for the pullover based on why the vehicle needs to pull over. The severity level may be used to identify a set of requirements or requirements for how the computing devices identify a pullover location. These pullover locations can include simply areas of the map that meet the set of requirements and/or predesignated stopping locations identified in the map.

For instance, the computing devices may determine that the vehicle needs to be pulled over based on a variety of different types of inputs. As an example, a passenger may request that a vehicle pull over, a remote system such as a dispatching server or remote operator may send a message to the vehicle indicating that the vehicle should pull over, or the vehicle's systems may report a critical failure or other issue that requires the vehicle to pull over.

Each of these different types of inputs may be assigned a severity level. For instance, passenger-requested pullovers may have different severity level depending on the circumstances of the request. When a pullover is required based on a message received from a dispatching server, the message itself may identify a severity level. In addition, different types of pullovers determined from information reported to the vehicle's computing devices by various systems of the vehicle may have different severity levels.

Once the severity level is identified, the vehicle's computing devices may identify a set of requirements which the vehicle's computing devices may use when attempting to identify a pull over location. The higher the severity level, the more flexible or shorter the list of requirements may be. Similarly, the lower the severity level, the greater and more restrictive the list of requirements may be.

The identified set of requirements may then be used to conduct a search over the roadgraph starting at the current position of the vehicle. In this regard, a simple graph search algorithm which stops when a location that meets all requirements of the identified set of requirements may be used. Once the search has stopped on a location, the vehicle's computing devices may then set the location that meets all of the requirements as the destination for the vehicle and control the vehicle in order to reach that location.

The features described above allow a computing device to react to a need to pull the vehicle over in a way which takes into account why the vehicle needs to pullover. This can also avoid situations in which the vehicle performs maneuvers which would make a passenger feel uncomfortable, such as sudden lane changes or turns, when such maneuvers are not actually necessary.

### Example Systems

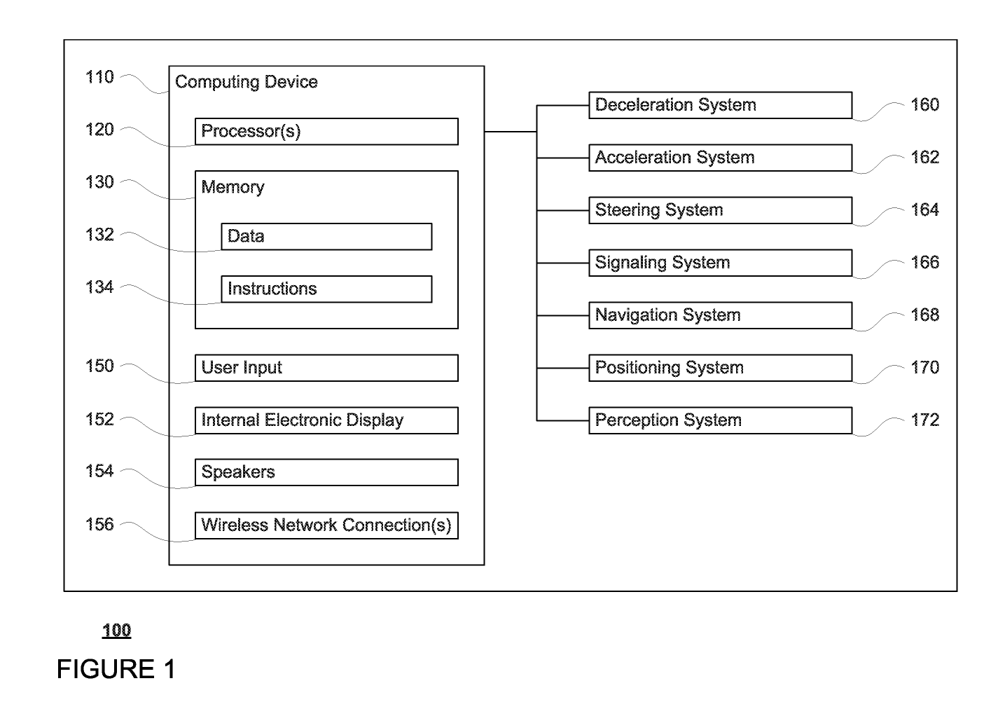

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100.

Computing device 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

In one example, computing device 110 may be an autonomous driving computing system incorporated into vehicle 100. The autonomous driving computing system may capable of communicating with various components of the vehicle. For example, returning to FIG. 1, computing device 110 may be in communication with various systems of vehicle 100, such as deceleration system 160, acceleration system 162, steering system 164, signaling system 166, navigation system 168, positioning system 170, and perception system 172 in order to control the movement, speed, etc. of vehicle 100 in accordance with the instructions 134 of memory 130. Again, although these systems are shown as external to computing device 110, in actuality, these systems may also be incorporated into computing device 110, again as an autonomous driving computing system for controlling vehicle 100.

As an example, computing device 110 may interact with deceleration system 160 and acceleration system 162 in order to control the speed of the vehicle. Similarly, steering system 164 may be used by computer 110 in order to control the direction of vehicle 100. For example, if vehicle 100 is configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Navigation system 168 may be used by computing device 110 in order to determine and follow a route to a location. In this regard, the navigation system 168 and/or data 132 may store detailed map information, e.g., highly detailed maps identifying the shape and elevation of roadways, lane lines, intersections, crosswalks, speed limits, traffic signals, buildings, signs, real time traffic information, pull over spots vegetation, or other such objects and information. As discussed further below, these pull over spots may be “hand” selected or identified areas where at which the vehicle is lawfully able to stop and park for some period of time such as shoulder areas, parking spots, parking lots, emergency pull over spots, etc.

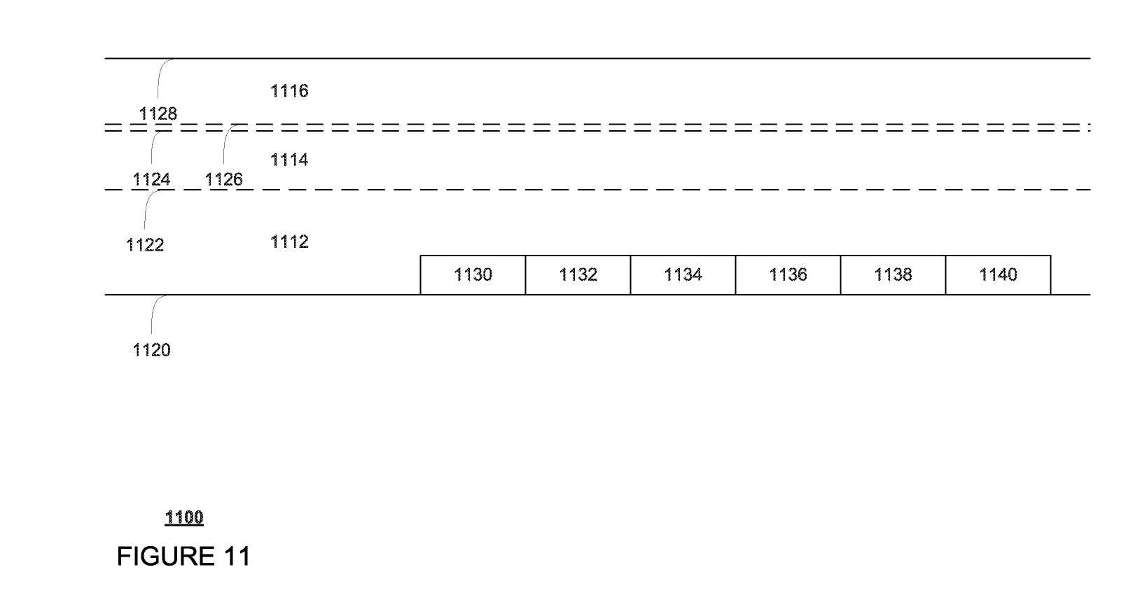

FIG. 11 is an example of map information 1100 for a section of roadway. The map information 1100 includes information identifying the shape, location, and other characteristics of various road features. In this example, the map information includes three lanes 1112, 1114, 1116 bounded by curb 1120, lane lines 1122, 1124, 1126, and curb 1128. Lanes 1112 and 1114 have the same direction of traffic flow (in an eastward direction), while lane 1116 has a different traffic flow (in a westward direction). In addition, lane 1112 is significantly wider than lane 1114, for instance to allow for vehicles to park adjacent to curb 1120. In this regard, the map information 1100 also includes a plurality of pre-designated pull over spots 1130-1140. Although the example of map information includes only a few road features, for instance, curbs, lane lines, and lanes, given the nature of the roadway of map information 1100, the map information may also identify various other road features such as traffic signal lights, crosswalks, sidewalks, stop signs, yield signs, speed limit signs, road signs, etc. Although not shown, the detailed map information may also include information identifying speed limits and other legal traffic requirements as well as historical information identifying typical and historical traffic conditions at various dates and times.

Positioning system 170 may be used by computing device 110 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with computing device 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by computing device 110. In the case where the vehicle is a small passenger vehicle such as a car, the car may include a laser or other sensors mounted on the roof or other convenient location.

The computing device 110 may control the direction and speed of the vehicle by controlling various components. By way of example, computing device 110 may navigate the vehicle to a destination location completely autonomously using data from the detailed map information and navigation system 168. Computing device 110 may use the positioning system 170 to determine the vehicle's location and perception system 172 to detect and respond to objects when needed to reach the location safely. In order to do so, computing device 110 may cause the vehicle to accelerate (e.g., by increasing fuel or other energy provided to the engine by acceleration system 162), decelerate (e.g., by decreasing the fuel supplied to the engine, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 160 may be a part of a drivetrain that includes various components between an engine of the vehicle and the wheels of the vehicle. Again, by controlling these systems, computing device 110 may also control the drivetrain of the vehicle in order to maneuver the vehicle autonomously.

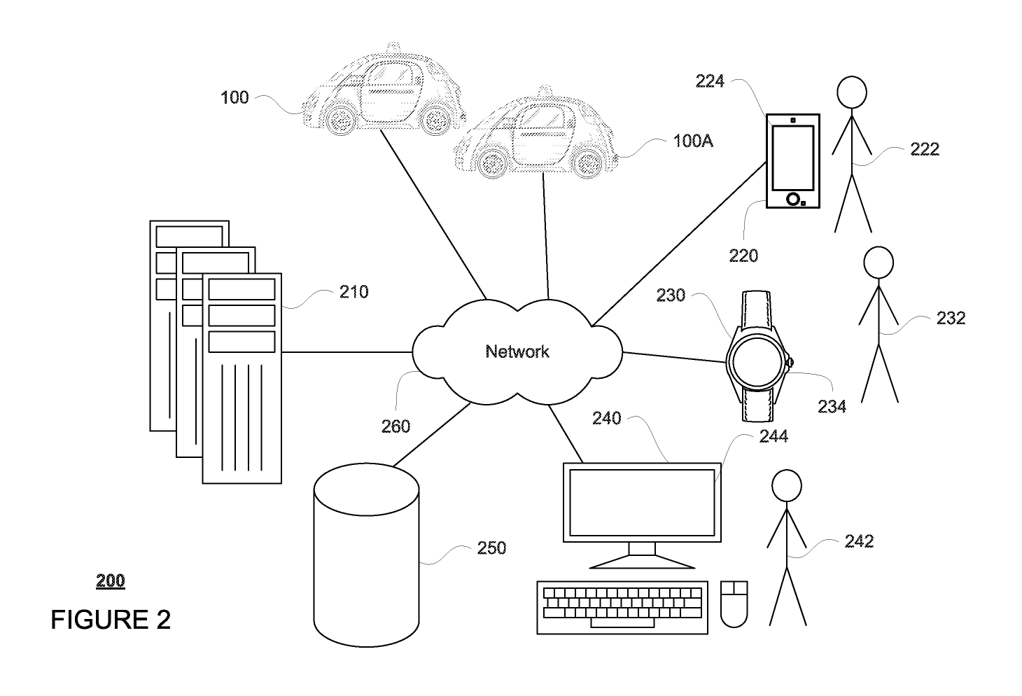

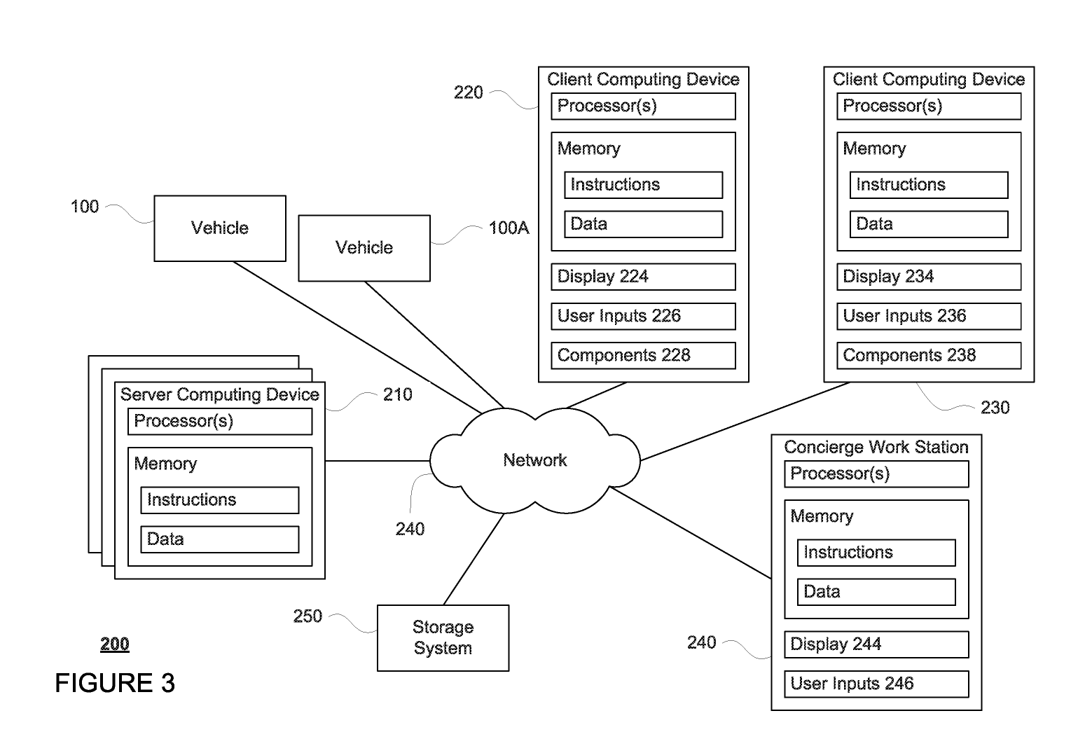

Computing device 110 of vehicle 100 may also receive or transfer information to and from other computing devices. FIGS. 2 and 3 are pictorial and functional diagrams, respectively, of an example system 200 that includes a plurality of computing devices 210, 220, 230, 240 and a storage system 250 connected via a network 260. System 200 also includes vehicle 100, and vehicle 100A which may be configured similarly to vehicle 100. Although only a few vehicles and computing devices are depicted for simplicity, a typical system may include significantly more.

As shown in FIG. 3, each of computing devices 210, 220, 230, 240 may include one or more processors, memory, data and instructions. Such processors, memories, data and instructions may be configured similarly to one or more processors 120, memory 130, data 132, and instructions 134 of computing device 110.

The network 260, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 110 may include a server having a plurality of computing devices, e.g., a load balanced server farm, that exchange information with different nodes of a network for the purpose of receiving, processing and transmitting the data to and from other computing devices. For instance, one or more computing devices 210 may include one or more server computing devices that are capable of communicating with computing device 110 of vehicle 100 or a similar computing device of vehicle 100A as well as computing devices 220, 230, 240 via the network 260. For example, vehicles 100 and 100A may be a part of a fleet of vehicles that can be dispatched by server computing devices to various locations. In this regard, the vehicles of the fleet may periodically send the server computing devices location information provided by the vehicle's respective positioning systems and the one or more server computing devices may track the locations of the vehicles.

In addition, server computing devices 210 may use network 260 to transmit and present information to a user, such as user 222, 232, 242 on a display, such as displays 224, 234, 244 of computing devices 220, 230, 240. In this regard, computing devices 220, 230, 240 may be considered client computing devices.

As shown in FIG. 3, each client computing device 220, 230, 240 may be a personal computing device intended for use by a user 222, 232, 242, and have all of the components normally used in connection with a personal computing device including a one or more processors (e.g., a central processing unit (CPU)), memory (e.g., RAM and internal hard drives) storing data and instructions, a display such as displays 224, 234, 244 (e.g., a monitor having a screen, a touch-screen, a projector, a television, or other device that is operable to display information), and user input devices 226, 236, 246 (e.g., a mouse, keyboard, touchscreen or microphone). The client computing devices may also include a camera for recording video streams, speakers, a network interface device, and all of the components used for connecting these elements to one another.

In addition, the client computing devices 220 and 230 may also include components 228 and 238 for determining the position and orientation of client computing devices. For example, these components may include a GPS receiver to determine the device's latitude, longitude and/or altitude as well as an accelerometer, gyroscope or another direction/speed detection device as described above with regard to positioning system 170 of vehicle 100.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system, or a netbook that is capable of obtaining information via the Internet or other networks. In another example, client computing device 230 may be a wearable computing system, shown as a wrist watch in FIG. 2. As an example the user may input information using a small keyboard, a keypad, microphone, using visual signals with a camera, or a touch screen.

In some examples, client computing device 240 may be a concierge work station used by an administrator to provide concierge services to users such as users 222 and 232. For example, a concierge 242 may use the concierge work station 240 to communicate via a telephone call or audio connection with users through their respective client computing devices or vehicles 100 or 100A in order to facilitate the safe operation of vehicles 100 and 100A and the safety of the users as described in further detail below. Although only a single concierge work station 240 is shown in FIGS. 2 and 3, any number of such work stations may be included in a typical system.

Storage system 250 may store various types of information as described in more detail below. This information may be retrieved or otherwise accessed by a server computing device, such as one or more server computing devices 210, in order to perform some or all of the features described herein. For example, the information may include user account information such as credentials (e.g., a user name and password as in the case of a traditional single-factor authentication as well as other types of credentials typically used in multi-factor authentications such as random identifiers, biometrics, etc.) that can be used to identify a user to the one or more server computing devices. The user account information may also include personal information such as the user's name, contact information, identifying information of the user's client computing device (or devices if multiple devices are used with the same user account), as well as one or more unique signals for the user.

The storage system 250 may also store routing data for generating and evaluating routes between locations. For example, the routing information may be used to estimate how long it would take a vehicle at a first location to reach a second location. In this regard, the routing information may include map information, not necessarily as particular as the detailed map information described above, but including roads, as well as information about those road such as direction (one way, two way, etc.), orientation (North, South, etc.), speed limits, as well as traffic information identifying expected traffic conditions, etc.

As with memory 130, storage system 250 can be of any type of computerized storage capable of storing information accessible by the server computing devices 210, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2 and/or may be directly connected to or incorporated into any of the computing devices 110, 210, 220, 230, 240, etc.

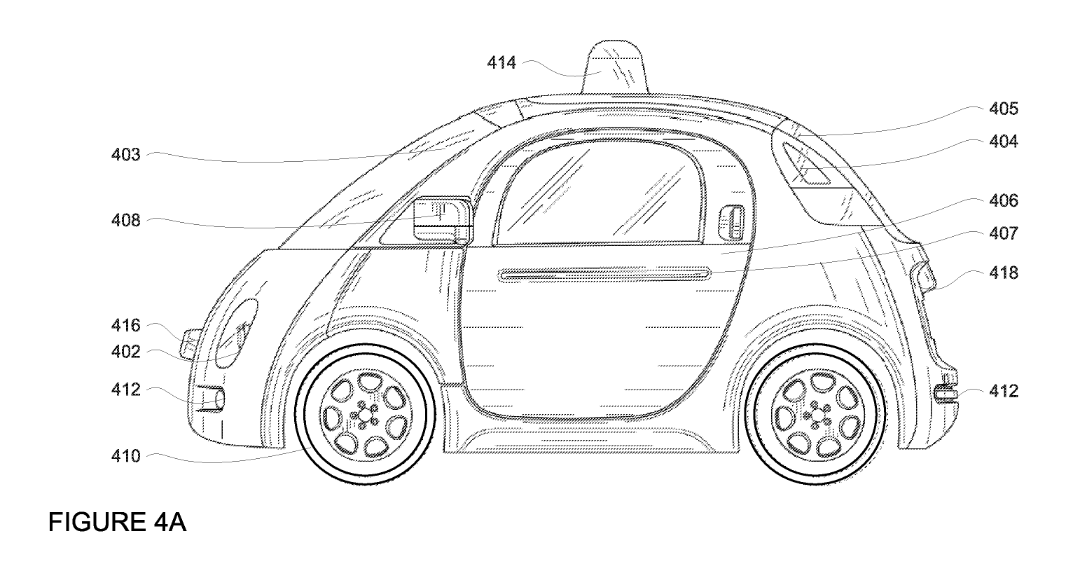

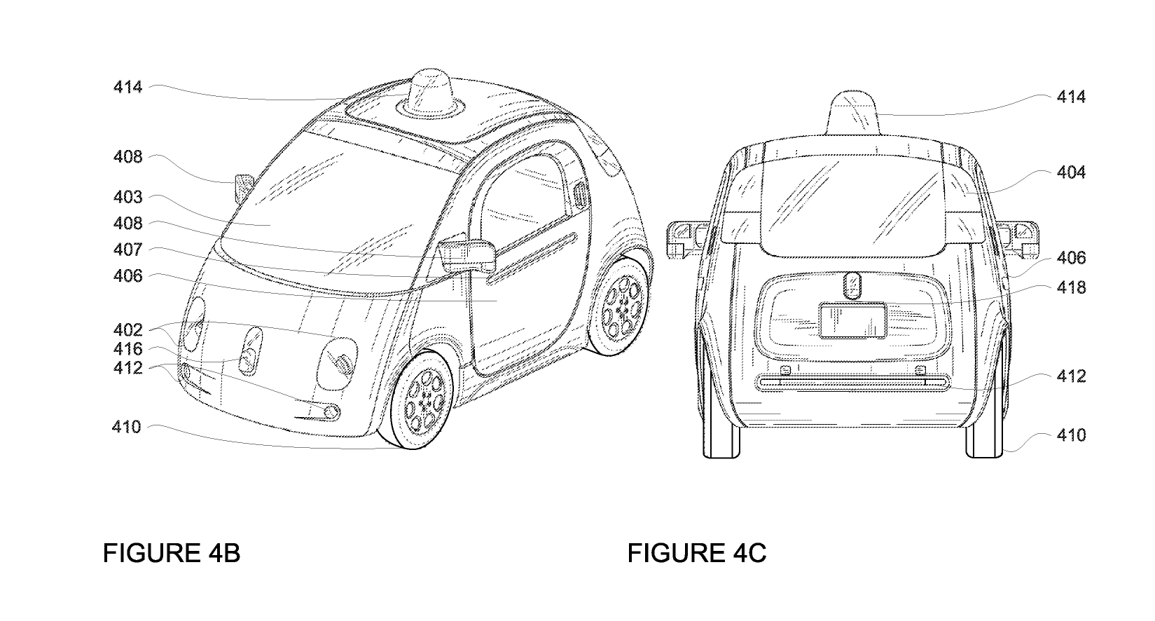

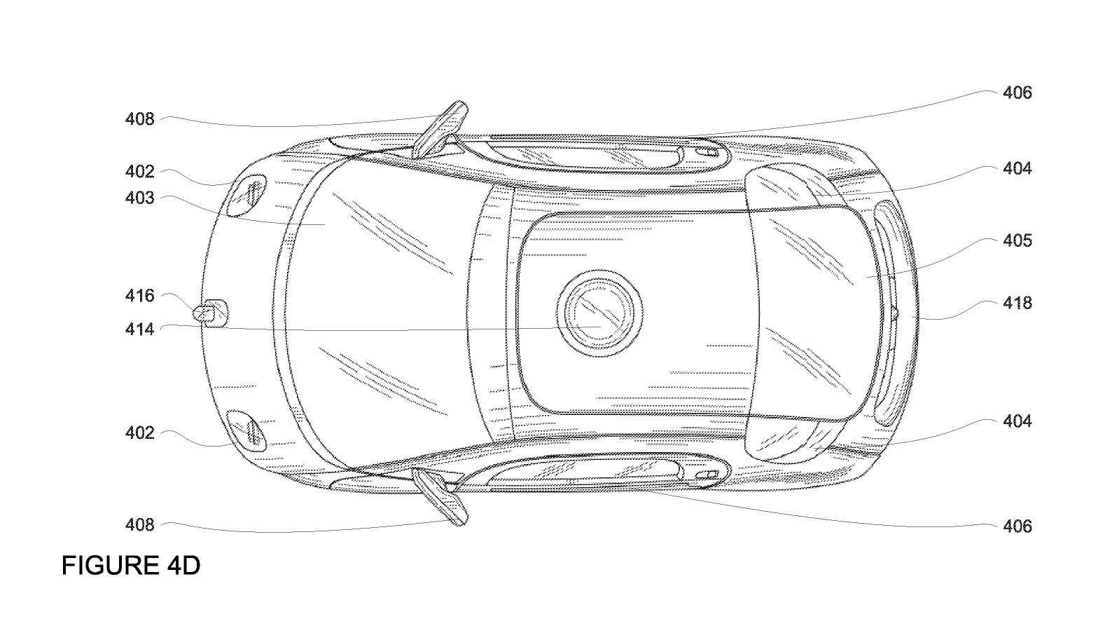

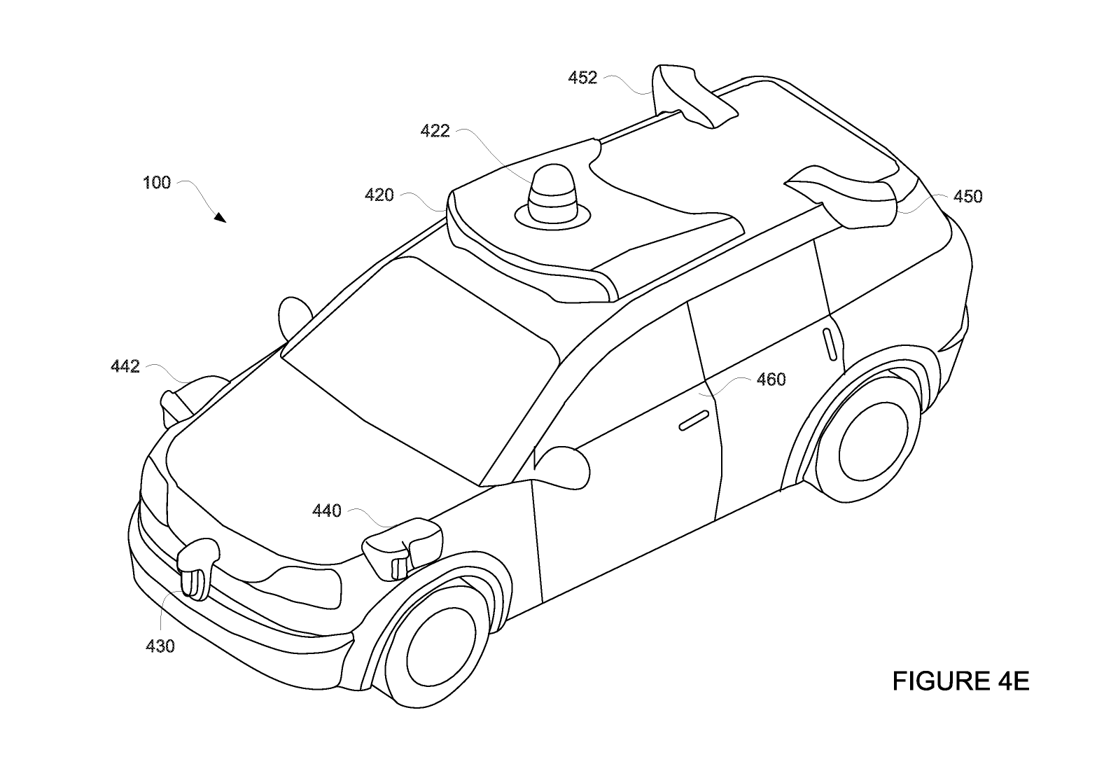

FIGS. 4A-4D are examples of external views of vehicle 100. As can be seen, vehicle 100 includes many features of a typical vehicle such as headlights 402, windshield 403, taillights/turn signal lights 404, rear windshield 405, doors 406, side view mirrors 408, tires and wheels 410, and turn signal/parking lights 412. Headlights 402, taillights/turn signal lights 404, and turn signal/parking lights 412 may be associated the signaling system 166. Light bar 407 may also be associated with the signaling system 166.

Vehicle 100 also includes sensors of the perception system 172. For example, housing 414 may include one or more laser devices for having 360 degree or narrower fields of view and one or more camera devices. Housings 416 and 418 may include, for example, one or more radar and/or sonar devices. The devices of the perception system may also be incorporated into the typical vehicle components, such as taillights/turn signal lights 404 and/or side view mirrors 408. Each of these radar, camera, and lasers devices may be associated with processing components which process data from these devices as part of the perception system 172 and provide sensor data to the computing device 110.

FIG. 3E is a second example configuration for vehicle 100. In this example, roof-top housing 420 and dome housing 422 may include a lidar sensor as well as various cameras and radar units. In addition, housing 430 located at the front end of vehicle 100 and housings 440, 442 on the driver's and passenger's sides of the vehicle may each store a lidar sensor. For example, housing 440 is located in front of driver door 460. Vehicle 100 also includes housings 450, 452 for radar units and/or cameras also located on the roof of vehicle 100. Additional radar units and cameras (not shown) may be located at the front and rear ends of vehicle 100 and/or on other positions along the roof or roof-top housing 420.

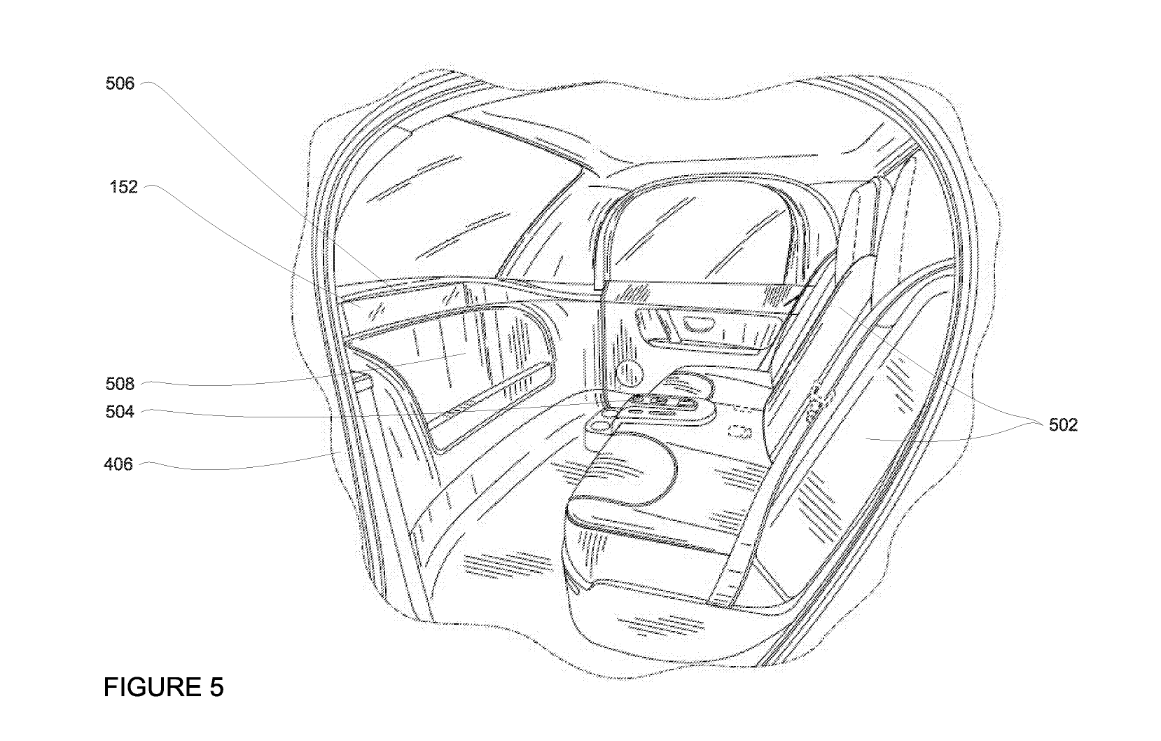

FIG. 5 is an example internal view of vehicle 100, for instance in the example configuration of FIGS. 3A-3D, through the opening of door 406. In this example, there are two seats 502 for passengers with a console 504 between them. Directly in ahead of the seats 502 is a dashboard configuration 506 having a storage bin area 508 and the internal electronic display 152. As can be readily seen, vehicle 100 does not include a steering wheel, gas (acceleration) pedal, or brake (deceleration) pedal which would allow for a semiautonomous or manual driving mode where a passenger would directly control the steering, acceleration and/or deceleration of the vehicle via the drivetrain. Rather, as described in further detail below, user input is limited to a microphone of the user input 150 (not shown), features of the console 504, and wireless network connections 156. In this regard, internal electronic display 152 merely provides information to the passenger and need not include a touch screen or other interface for user input. In other embodiments, the internal electronic display 152 may include a touch screen or other user input device for entering information by a passenger such as a destination, etc.

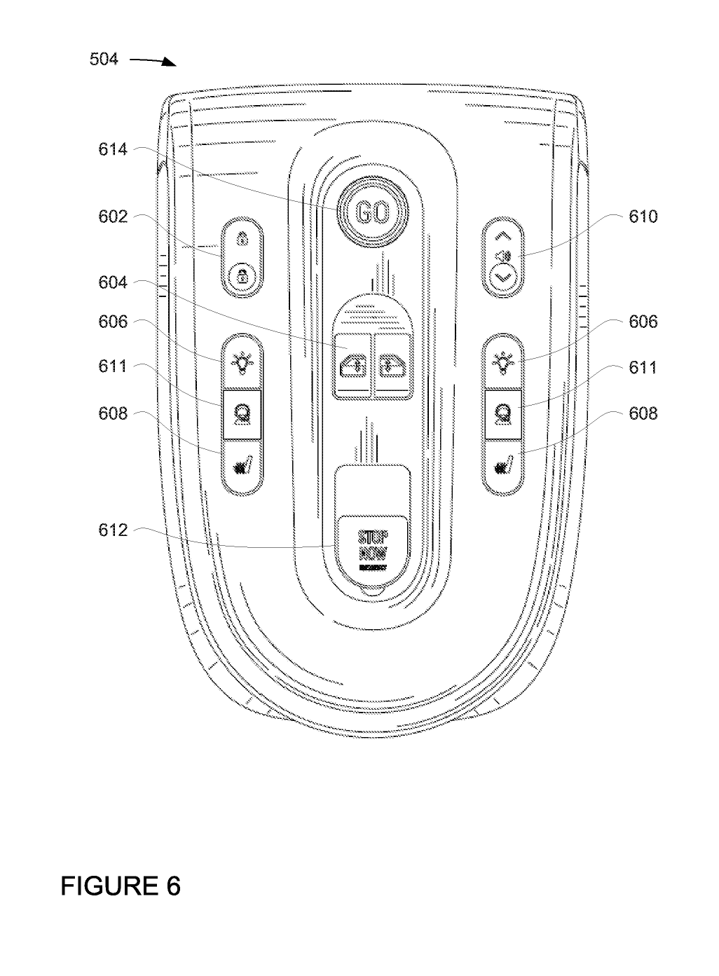

FIG. 6 is a top down view of the console 504. Console 504 includes various buttons for controlling features of vehicle 100. For example, console 504 includes buttons that may be found in a typical vehicle such as buttons 602 for locking and unlocking the doors 406, buttons 604 for raising or lowering the windows of doors 406, buttons 606 for turning on internal lights of the vehicle, buttons 608 for controlling a heating function of seats 502, as well as buttons 610 for controlling the volume of speakers 154.

In addition, console 504 also includes buttons 611 for initiating communication with concierge 242 via one of the wireless network connections 156. Once the concierge work station is connected to the vehicle, the concierge may send instructions to the computing devices 110, for instance, commanding, among other things, that the vehicle pull over as well as communicate with the passenger via the speakers 154 and/or internal electronic display 152. In addition, the microphone allows the passenger to speak directly to the concierge. In some cases, vehicle 100 may include an internal still or video camera that allows the concierge to view the status of the passengers and confirm their safety.

Buttons 612 and 614 may also be a part of user input 150 and in this regard, allow a passenger to communicate with computing device 110, for example, to initiate or end a trip in the vehicle. In this regard, button 612 may act as an emergency stopping button that, when pushed, causes vehicle 100 to stop in a short amount of time. Because the passenger does not have direct control of the acceleration or deceleration of vehicle 100 by way of a gas or brake pedal, button 612 may be an emergency stop button that is critical to allowing a passenger to feel safe and act quickly in case of an immediate emergency. In addition, because of the potentially abrupt nature of a stop initiated by the emergency stopping button 612, the emergency stopping button 612 may feature a cover (e.g., a clear plastic cover) that may have to be removed or flipped up in order to activate button 612.

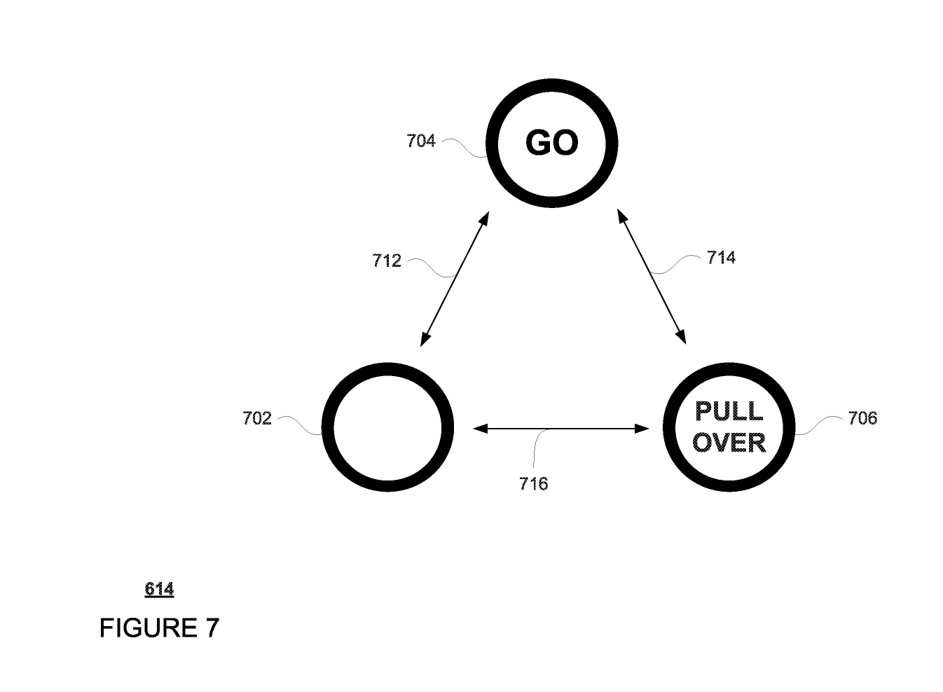

Button 614 may be a multi-function button. For example, FIG. 7 provides examples of the same button; here button 614, in three different states. In the first state 702, button 614 is inactive, that is, if pressed, the computer devices 110 would not respond by taking any particular action with regard to controlling the movement of the vehicle. However, even in this inactive state, the computing devices 110 may provide a passenger with some visual or audible feedback to indicate that the button is pressed. As an example, this feedback may indicate that the computer recognizes that the button was pressed or otherwise activated, but that button is currently inactive and the vehicle will not respond by maneuvering the vehicle in any particular way (e.g., not starting a trip or pulling over).

In the second state 704, when the vehicle is ready to begin a trip, the button 614 may change to a “GO” button which a passenger uses to initiate a trip to a destination or drop off location. Once vehicle 100 is moving, button 614 may change to a third state 706, where the button 614 is a “PULL OVER” button which a passenger users to initiate a non-emergency stop. In this regard, computer 110 may respond by determining a reasonable place to pull the vehicle over, rather than coming to a more sudden stop as with the emergency stop button 612. Arrows 712, 714, and 716 indicate that the states need not be displayed only in the order of first, second third, but may switch from second to first, third to first, third to second, etc. as dictated by the needs of computer 110.

In addition or alternatively, rather than having a single multipurpose button, such as button 614, two buttons with different states of activation may be used. In this regard, a first button may have an inactive state and an active or “GO” state which enables a passenger to initiate a trip to a destination or drop off location. A second button may have an inactive state and an active or “PULL OVER” state which enables a passenger to initiate a non-emergency stop. In some examples, when the first button is in the active state, the second button is in the inactive state. Similarly, when the second button is in the active state, the first button may be in the inactive state. In some instances, before the vehicle is ready to start a trip to a drop off location, both the first and second buttons may be in the inactive state. In any event, when the vehicle is moving towards a destination location, computing device 110 may respond to a signal from button 614 by determining a safe place to pull the vehicle over, rather than coming to a more sudden stop as with the emergency stop button 612.

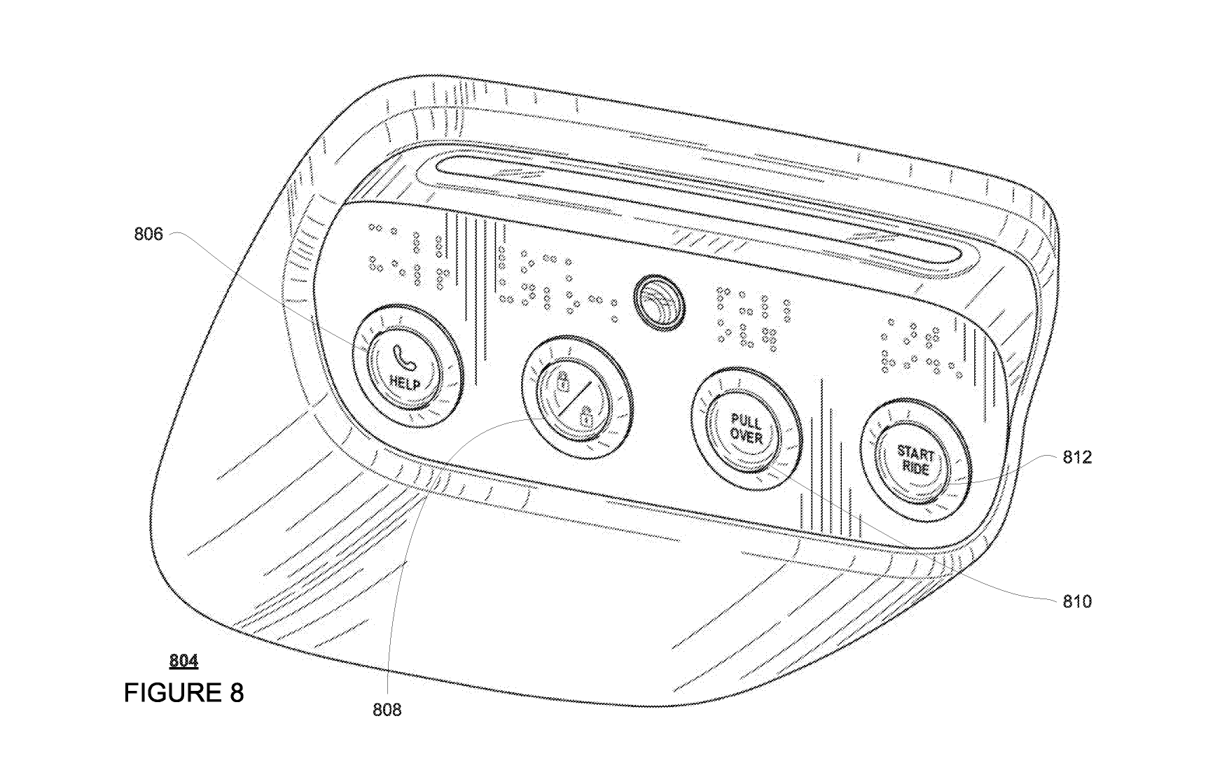

Alternatively, two buttons, one having a “GO” state and the other having a “PULL OVER” state may be used. For example, FIG. 8 is a side perspective view of a console 804 having a set of buttons which may be part of user input 150. This console may be used, for instance with the configuration of vehicle 100 as depicted in FIGS. 3A-3D or the configuration depicted in FIG. 4E. The set of buttons in this example includes two buttons which can initiate a trip or cause the vehicle to pull over. Console 804 may be positioned on an interior of vehicle 100 at a headliner area (the interior surface of the roof of the vehicle. Console 804 may be used as an alternative to console 504 or in addition to console 504. In this example, console 804 includes buttons 806, 808, 810, and 812. Each of these buttons operates to send a signal to the computing devices 110. In response to the signal from button 806, the computing devices 110 may connect the passenger with a concierge. A signal from button 808 may cause the computing devices 110 to lock or unlock the doors (depending upon the current state of the doors). A signal from button 810 may cause the computing devices to pull the vehicle over, similar to the operation of the button 614 when in the “PULL OVER” state. A signal from button 812 may cause the computing devices to initiate a trip to a destination, similar to the operation of the button 614 when in the “GO” state.

Thus, passenger communication with computing device 110 for navigation purposes may be limited to buttons such as button 614 and emergency stopping button 612 and/or button, wireless network connection 156 (such as Bluetooth LE) with the passenger's client computing device, and by sending information from the passenger's client computing device to the server computing devices 210 which then relays that information to the computing devices 110. In some examples, a passenger may provide information to the computing device 110 via voice commands through the microphone as discussed above. In addition, however, the passenger may communicate with the concierge via a phone call, an application on the passenger's client computing device, a microphone, and/or the button 611 and in turn, the concierge may provide instructions control certain aspects of a vehicle via a concierge work station.

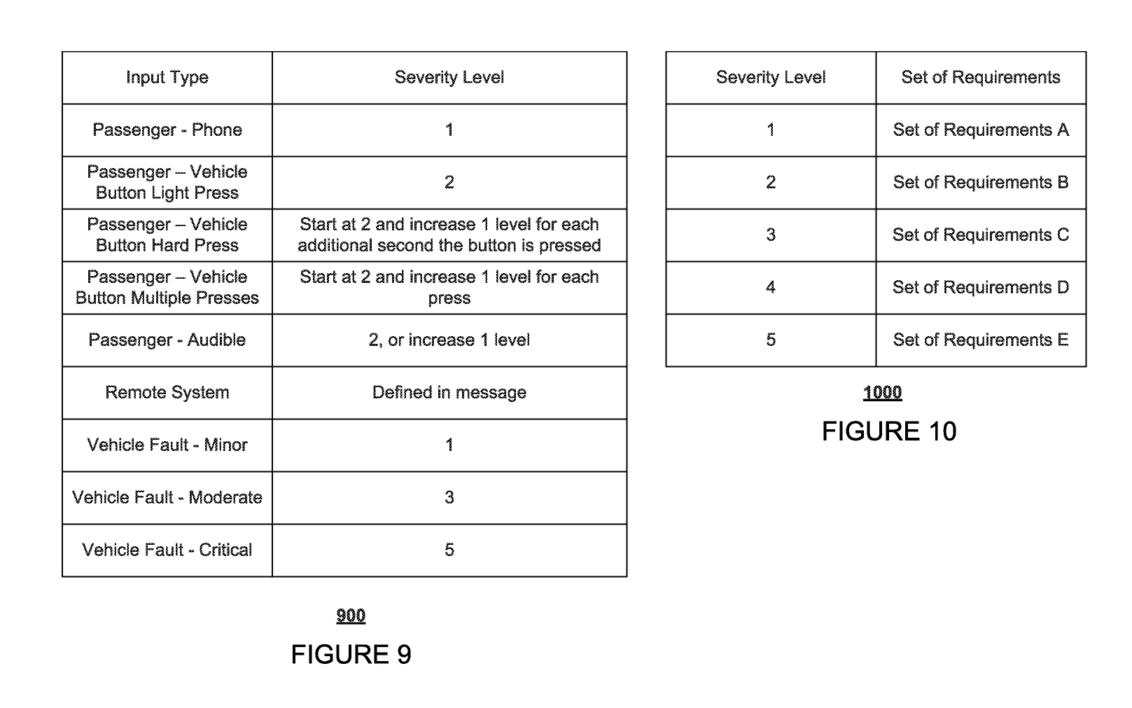

Data 132 may also store severity level information. As one example, these severity level information may be arranged within a lookup table which identifies different types and circumstances of pullovers and associates each with a particular severity level. For instance, pull over inputs may come from a passenger via a passenger's client computing device, a remote server computing device, and/or messages received from various systems of the vehicle reporting faults or errors. Referring to Table 900 of FIG. 9, passenger requested pullovers may have different severity level depending on the circumstances of the request. For instance, if a passenger requests a pullover using his or her phone, such as one of client computing devices 220 or 230 discussed further below, this may have a first severity level, shown as “Severity Level 1” in Table 900. If a passenger requests a pullover using a button in the vehicle, such as buttons 614 or 810 discussed further below, this may have a second severity level, greater than the first severity level. For instance, Table 900 indicates that such an input corresponds to a “Severity Level 2.”

The severity level may also be increased based on the circumstances of “how” the passenger presses the button. In this regard, a single “light” press may be lower in severity than multiple light presses or one or multiple “hard” presses. In other words, additional presses or multiple hard presses (determined using a force sensor at the button) may increase the severity level. For instance, as shown in Table 900, for hard button presses, the severity level starts at “Severity Level 2” and increases by 1 level for each additional second that the button is pressed. If there are multiple presses, the severity level starts at “Severity Level 2” and increases by 1 level for each additional press of the button.

Similarly, audible and/or visual information, generated using an interior microphone and/or video, may capture the reaction of the passenger. In this regard, shouting for help, may also increase the severity level. Again, referring to the table, if there is audible input this may be a “Severity Level 2,” but if there is already another input, such as a button press or phone input, the severity level may be increased by 1 level.

When a pullover is required based on a message received from a remote system such as a dispatching server or remote operator, such as concierge 242 using concierge work station 240, the message itself may identify a severity level. In this regard, Table 900 indicates that the computing devices should refer to the information in the message from the dispatching server. In this regard, different types of messages may be associated with different types of severity levels. In one example, a message which requires all vehicles to pullover because of a possible software issue related to control systems of the vehicle may have a higher severity level than a message which requires all vehicles to pullover because a rain or snow storm is expected to pass through in the next few minutes.

In addition, different types of pullovers determined from information reported to the vehicle's computing devices by various systems of the vehicle may have different severity levels. In this regard, more critical faults may result in higher severity levels as shown in Table 900. For instance, a critical system failure such as a complete failure of the deceleration system may have a higher severity than a failure of a redundant radar unit.

The data 132 may also store cross-reference information for identifying a set of requirements corresponding to each severity level. As an example, each severity level may be cross-referenced with a specific set of requirements using a second table, such as Table 1000 of FIG. 10, or some other storage system. The higher the severity level, the more flexible or shorter the list of requirements may be. Similarly, the lower the severity level, the greater and more restrictive the list of requirements may be. In this regard, Set of Requirements A may be longer and have more requirements than Set of Requirements B-E. Similarly, Set of Requirements B may be longer and have more requirements than Set of Requirements C-E, and so on.

Example requirements may include how soon the vehicle needs to be pulled over, whether the vehicle is permitted to pullover on a high speed (e.g. 35 mph road), whether the vehicle is permitted to pullover where the map lacks fully mapped road edge, whether the vehicle is permitted to pullover near a railroad tracks (as stopping on or very near railroad tracks can be a serious safety concern), whether the vehicle is permitted to pullover in an intersection, whether the pullover location must allow the vehicle to continue to the passenger's destination (without taking too much time to route back around), a number of permissible lane changes or maximum number of lane changes allowed, a number of permissible turns or maximum number of turns allowed, whether the vehicle must exit a highway immediately or if the vehicle is permitted to wait until a next exit which follows the route of the vehicle, whether the vehicle is permitted to pullover in a high traffic (people or vehicles) area, how much the pull over location will inconvenience a passenger (i.e. if the vehicle has to pull over, the computing devices should select a pull over location that is the most convenient for the passenger relative to their destination or at a location where they can most easily reach another vehicle to complete the trip), whether there is a lot of vehicular traffic (i.e. if there is a lot of traffic, it may be more difficult to make a lane change to exit a highway quickly), etc.

Regarding the fully mapped road edge example, this may be an important as if the computing devices do not have the details of the road edge in advance, the computing devices may not be able to determine how much the vehicle is actually able to shift to the right when pulling over. In addition, if there is no clear road edge, or if it is not defined in the map information, the computing devices may not be able to determine certain pullover restrictions (i.e. legal parking requirements for the area). In another example, if the pull over is required due to a failure in the perception system, the computing devices may not be able to determine curb colors or parking restrictions that might apply, whereas if the road edge is fully mapped, this information is likely to be included in the map information.

As an example, for very low severity levels such as “Severity Level 1” or “Severity Level 2”, the set of requirements may include identifying a location that will allow the vehicle to continue to the final destination for a trip or to do so without adding too much time onto the trip and require that the vehicle pull over into a pre-designated pull over spot of the map information, such as any of pull over spots 1130-1140 of map information 1100. This may be less important for higher severity levels.

In addition, for lower severity levels, making multiple lane changes or waiting for a highway exit may be appropriate, however as the severity level increases, these may no longer be appropriate and may therefore be avoided or restricted. For instance, if the vehicle is in a leftmost lane of a highway, for a very high severity level, such as “Severity Level 4” or “Severity Level 5,” the vehicle may be pulled onto a center median or stopped in a current lane. For a slightly lower severity level, such as “Severity Level 3” the vehicle may be moved across one or more other lanes in order to reach a shoulder area. For an even lower severity level, such as “Severity Level 2” the vehicle may be allowed to exit the highway and stop in a residential area or to continue to at a different exit along the route and pullover after exiting at the different exit. As another example, as the severity increases, or gets closer to “Severity Level 5,” the number of lane changes or turns allowed may be reduced while more aggressive behaviors with regard to stopping in a lane of traffic, lane changes or turns may be permitted.

While Tables 900 and 1000 depict only a few severity levels for a few inputs, various different types of severity levels, scales and inputs may be used.

In addition to the operations described above and illustrated in the figures, various operations will now be described. It should be understood that the following operations do not have to be performed in the precise order described below. Rather, various steps can be handled in a different order or simultaneously, and steps may also be added or omitted.

In one aspect, a user may download an application for requesting a vehicle to a client computing device. For example, users 222 and 232 may download the application via a link in an email, directly from a website, or an application store to client computing devices 220 and 230. For example, client computing device may transmit a request for the application over the network, for example, to one or more server computing devices 210, and in response, receive the application. The application may be installed locally at the client computing device.

The user may then use his or her client computing device to access the application and request a vehicle. As an example, a user such as user 232 may use client computing device 230 to send a request to one or more server computing devices 210 for a vehicle. The request may include information identifying a pickup location or area and/or a destination location or area. As an example, such location may be identified by street addresses, location coordinates, points of interest, etc. In response the one or more server computing devices 210 may identify and dispatch, for example based on availability and location, a vehicle such as vehicle 100 to the pickup location. This dispatching may involve sending information to the vehicle identifying the user (and/or the user's client device), the pickup location, and the destination location or area.

The computing devices 110 may use the information from the server computing devices to identify a pick up location and destination location for an assigned passenger. The computing devices 110 may then maneuver the vehicle towards the pickup location as discussed above. Once the vehicle is some predetermined distance from the pickup location, the computing devices 110 may attempt to stop the vehicle at a location proximate to the pickup location in order to allow the passenger to enter. Once the passenger has entered the vehicle, he or she may be asked to perform some tasks such as buckle a seat belt, close a door, confirm his or her destination as that of the assigned passenger, and initiate a trip to the passenger's destination location. This initiation may be performed, for instance by using button 614 (when in the “GO” state) or button 812. In response to a signal from one of these buttons, the computing devices 110 may begin to maneuver the vehicle 100 towards the destination location for the passenger.

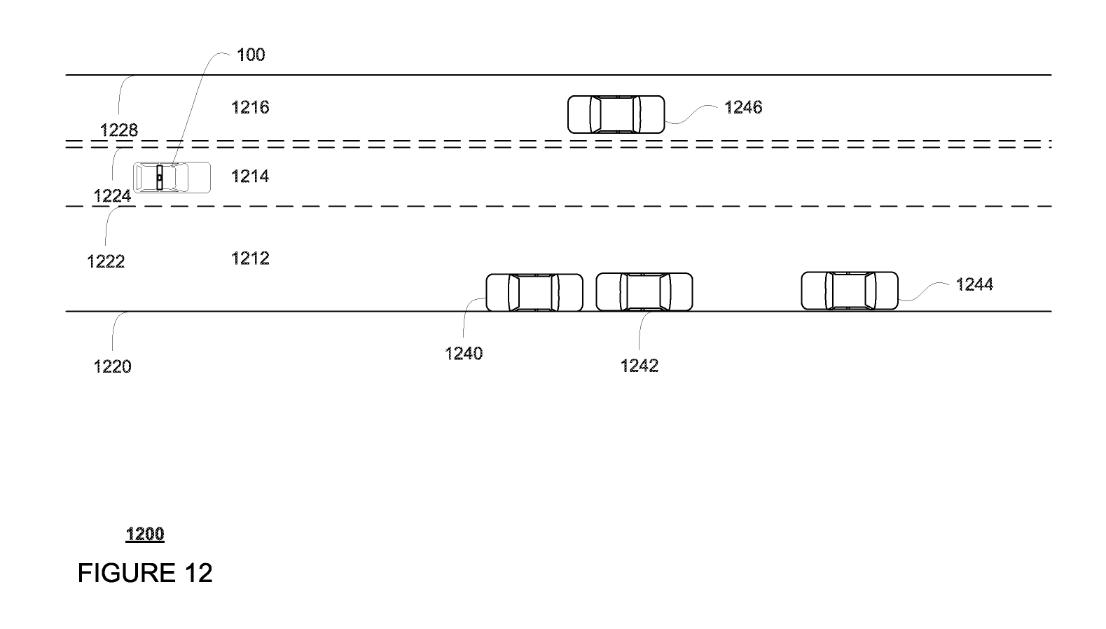

FIG. 12 is an example view of vehicle 100 driving along a roadway 1200 corresponding to the map information 1100 of FIG. 11. In that regard, lanes 1212, 1214, 1216 correspond to the shape and location of lanes 1112, 1114, 1116, curbs 1220, 1228 correspond to the shape and location of curb 1120, and lane lines 1222, 1224, 1226 correspond to the shape and location of lane lines 1122, 1124, 1126, and curb 1128. In this example, vehicle 120 is traveling in lane 1212. Vehicles 1240, 1242, and 1244 are parked within lane 1212 along curb 1220, while vehicle 1246 is moving in lane 1216 and vehicle 110 is moving in lane 1214. Because pull over spots 1130, 1132, 1134, 1136, 1138, 1140 merely correspond to a shoulder area where vehicle 120 could lawfully park for some period of time, there is no corresponding “real world” feature included in FIG. 12.

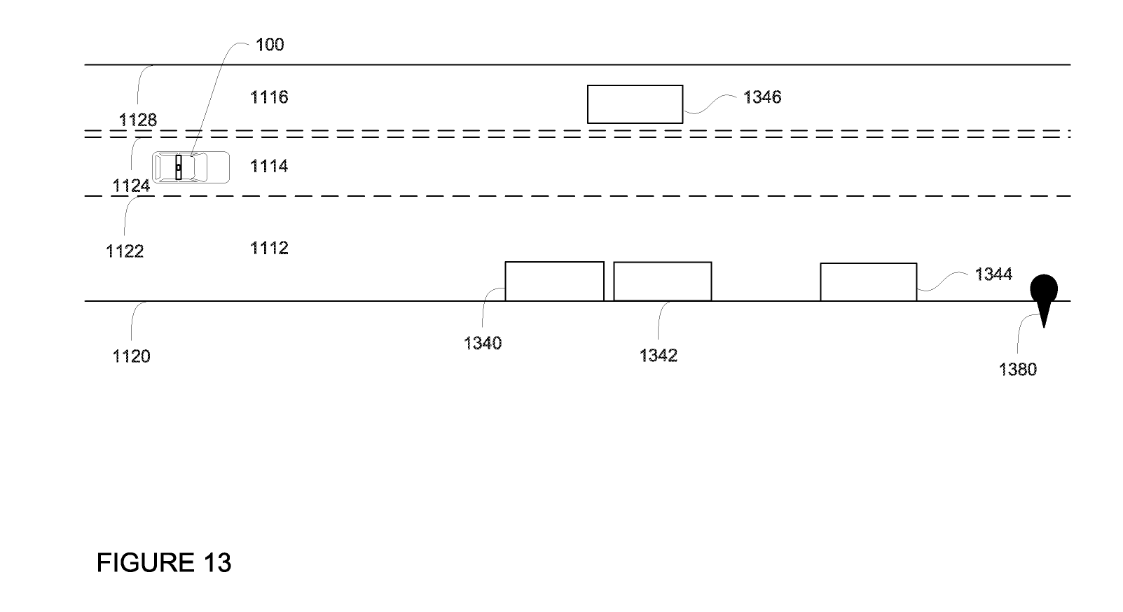

As the vehicle moves along lane 1214, the perception system 172 provides the computing devices with sensor data regarding the shapes and location of objects, such as curbs 1220, 1228, lane lines 1222, 1224, 1224, as well as vehicles 1240, 1242, 1244, 1246. FIG. 13 depicts sensor data perceived by the various sensors of the perception system 172 when vehicle 120 is in the situation as depicted in FIG. 12 in combination with other information available to the computing devices 110. In this example, vehicles 1240, 1242, 1244, 1246, are represented by bounding boxes 1340, 1342, 1344, 1346 as provided by the perception system 172 to the computing devices 110. Of course, these bounding boxes represent merely a volume of space within which data points corresponding to an object are at least approximately bounded within. In addition, in FIG. 13, the destination location for passenger (assuming a passenger is in the vehicle) is represented by a marker 1380, though the marker 1380 could alternatively indicate some other location, such as a pickup location, waiting location, or service location of the vehicle.

At some point, the computing devices may determine that the vehicle needs to be pulled over based on a variety of different types of inputs. As an example, a passenger, such as user 232, whose client computing device 230 has already been authenticated by the computing devices 110 may request that a vehicle pullover using a virtual button displayed on the client computing device via the application described above. Although not required, for simplicity, the layout of virtual buttons displayed on a touch-sensitive display of the client computing device may mimic the layout of the buttons of the vehicle in order to give the passenger greater context about what the buttons mean. In another example, along the way to the destination location, represented by marker 1180, a passenger may express intent to stop the vehicle to the computing devices 110 by pressing a button, such as buttons 614 or 810, in the vehicle. As another example, the computing devices 110 may receive a message from a remote system, such as one of the server computing devices 210 or a remote operator such as concierge 242 via concierge work station 240, indicating that all vehicles or any vehicle meeting certain criteria must pull over. This message may be sent and received, for instance, via network 260.

As noted above, of these different types of inputs may be assigned a severity level. As one example, these severity levels may be determined using a lookup table, such as Table 1100 of FIG. 11, which identifies different types and circumstances of pullovers and associates each with a particular severity level. The computing devices 110 may use the type of input to identify a severity level for the pull over. For instance, as discussed above, the computing devices 110 may access Table 1100 of FIG. 11 to identify a severity level. As an example, if user 232 uses client computing device 230 to request that the vehicle pull over, the input may be a “Passenger—Phone” type, and thus, the computing devices 110 may identify “Severity Level 1.” In another example, if the users uses button 614 or 820 to request that the vehicle pull over and presses the button once lightly, the input may be “Passenger—Vehicle Button Light Press” and the computing devices 110 may identify “Severity Level 2.” If the press is a hard one for two seconds, the input may be a Passenger—Vehicle Button Hard Press” increased 1 level for each of the two seconds, and the computing devices 110 may identify “Severity Level 4.” As another example, if the computing devices 110 receive a message from the server computing devices 210 requiring the vehicle to pull over, as indicated in Table 1100, the computing devices 110 may identify the severity level for the pull over in the message. Similarly, if the computing devices 110 receive a message from the concierge 242 via concierge work station 240 requiring the vehicle to pull over, as indicated in Table 1100, the computing devices 110 may identify the severity level for the pull over in the message. In a further example, if the computing devices 110 receive a fault message from one of the systems of the vehicle, such as any of the systems identified in FIG. 1 or any other system of the vehicle, the computing devices 110 may identify the severity level based on how critical the fault is as shown in Table 1100.

Once the severity level is identified, the vehicle's computing devices may identify a set of requirements. Referring to Table 1000 of FIG. 10, for “Severity Level 1” the computing devices may identify “Set of Requirements A,” for “Severity Level 2” the computing devices may identify “Set of Requirements B,” and so on.

The identified set of requirements may then be used to conduct a search over the roadgraph starting at the current position of the vehicle. In this regard, a simple graph search algorithm which stops when a location that meets all requirements of the identified set of requirements may be used. Once the search has stopped on a location, the vehicle's computing devices may then set the location that meets all of the requirements as the destination for the vehicle and control the vehicle in order to reach that location.

For instance, referring to FIG. 13, for a low severity level, such as “Severity Level 1” or “Severity Level 2” the computing devices 110 may maneuver the vehicle to pull over after bounding box 1244 (or in parking spot 1140 shown in FIG. 11) as these severity levels may have the most restrictive requirements for the vehicle's behavior and pull over location in the Set of Requirements A or B. For a slightly higher severity level, such as “Severity Level 3” the computing devices 110 may maneuver the vehicle to pull over or between bounding boxes 1342 and 1344 (or in parking area 1138 shown in FIG. 11) as the Set of Requirements C may allow the vehicle to take more aggressive actions in order to pull the vehicle over sooner than either Set of Requirements A or B. For a higher severity level, such as “Severity Level 4” the computing devices 110 may maneuver the vehicle into lane 1112 and pull behind bounding box 1340 (or in parking spot 1130 as shown in FIG. 11). Again, Set of Requirements D for “Severity Level 4” may allow for much more aggressive maneuvers than would be allowed under the Set of Requirements C for “Severity Level 3.” For the highest severity level, the computing devices 110 may simply stop the vehicle immediately in lane 1114 or move the vehicle into lane 1112 if possible as the Set of Requirements E may have the least restrictions on the vehicle's behavior and pull over location. Of course, the exact maneuvering of vehicle 100 will be dependent upon the circumstances including the surrounding environment of the vehicle, the type of input, the severity level, and the set of requirements.

More advanced searches, such as those that incorporate cost-based analyses could also be used. For instance, a forward graph search may be performed from the current position of the vehicle to identify the costs of different pull over spots relative to the current position of the vehicle, and a backward search may be performed from a current destination of the vehicle (i.e. a pickup location, drop off location, service location, etc.) to identify the costs of the different pull over spots relative to the current destination. Costs may be assessed, for instance using typical routing cost analyses such as the time and/or dirving distance to reach a location, the different types of maneuvers, etc. The computing devices may then identify the location that minimizes a weighted sum of the costs of the two searches and set that as the pull over location for the vehicle.

Alternatively, rather than simply identifying the closest location that meets the identified set of requirements, the computing devices may use a time limit identified using the severity level. In this regard, the time limit may decrease as the severity level increases. For instance, for major sensor failures, the time limit may be 30 seconds or more or less whereas for minor faults, such as where a sensor is near its end of life but still operating normally, the time limit may be 10 minutes or more or less.

If the destination is reachable within the time limit, the computing devices may simply continue to maneuver the vehicle to the destination along the current route that the vehicle is following. For instance, if marker 1380 represents a location that the vehicle is able to reach within the time limit, the computing devices 110 may continue to maneuver the vehicle to stop at or proximate to marker 1380 given the circumstances and parking spots available near marker 1380. In this example, the computing devices 110 may set the destination location as the pull over location such that the vehicle continues to the destination location and pulls over at or proximate to that location. The time limit may also be used to limit or timeout the search either because no location that meets the identified set of requirements has been found or the vehicle is not able to reach the identified location within the time limit. In such cases, the search may be repeated after relaxing one or more requirements of the identified set of requirements.

To avoid situations in which the vehicle may make a maneuver which would be uncomfortable for a passenger, for lower severity levels, such as “Severity Level 1” or “Severity Level 2” of the examples above, the computing devices 110 may continue to maneuver the vehicle along a current route for some predetermined period of time such as 5 or 10 seconds or more or less. As an example, this may prevent the vehicle from making an abrupt turn or lane change to get to the closest location that meets the identified set of requirements.

In some instances, when a pullover is required based on a message received from a remote system, the message may also define additional requirements for the search. For instance, if there is an incident reported that a particular vehicle of the fleet has a failure which indicates that other vehicles may not operate safely in certain situations, the message may identify additional requirements to avoid such situations. These requirements may include limiting the amount of or completely prohibiting highway driving, lane changes, unprotected left turns, etc. Alternatively, the remote system may provide a specific pullover point or location instead of a severity level or any additional requires. In such cases, a search for the pullover point may have been performed at the remote system, such as at the dispatching server computing devices 210 or by being selected “manually” by the concierge 242 via the concierge work station 240.

Similarly, when a pullover is required because of a certain fault at the vehicle, the type of fault may also define additional requirements or capability requirements for the search. For instance, a vehicle may experience a fault which makes it no longer safe to make a lane change to the right or left, such as because the perception system cannot reliably detect objects in this area. As another example, if one or more cameras of the perception system which are used to detect the condition of traffic signal lights are not functional, the vehicle may be required to avoid routing intersections controlled by traffic signal lights.

In another example, if a user requests a pullover from a concierge or live help operator, the live help operator can define the severity level, define the set of requirements, and/or event direct the vehicle to a particular pullover location.

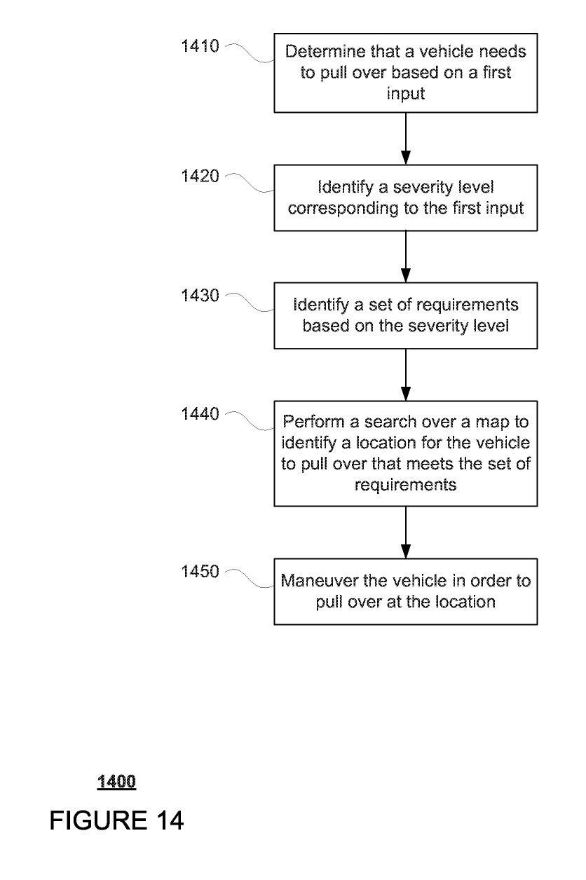

FIG. 14 is a flow diagram 1400 that may be performed by one or more processors, such as one or more processors of the computing devices 110, to maneuver a vehicle in an autonomous driving mode. For instance, at block 1410 the vehicle needs to pullover is determined based on a first input. At block 1420, a severity level corresponding to the first input is identified. At block 1430, a set of requirements is identified based on the severity level. At block 1440, search is performed over a map to identify a location for the vehicle to pull over that meets the set of requirements. At block 1450, the vehicle is maneuvered in order to pull over at the location.

Unless otherwise stated, the foregoing alternative examples are not mutually exclusive, but may be implemented in various combinations to achieve unique advantages.

As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of maneuvering a vehicle in an autonomous driving mode, the method comprising:
determining, by one or more processors, that the vehicle needs to pullover based on a first input;
identifying, by the one or more processors, a severity level corresponding to the first input;
identifying, by the one or more processors, a set of requirements based on the severity level;
performing, by the one or more processors, a search over a map to identify a location for the vehicle to pull over that meets the set of requirements; and
maneuvering, by the one or more processors, the vehicle in order to pull over at the location.

2. The method of claim 1, wherein the first input is an input from a passenger of the vehicle, and the method further includes:
identifying a first severity level based on the input; and
increasing the first severity level to the severity level based on circumstances of the input.

3. The method of claim 2, wherein the circumstances include a number of times the passenger has used a button to generate the input.

4. The method of claim 2, wherein the circumstances include an amount of force the passenger has used a button to generate the input.

5. The method of claim 2, wherein the circumstances include audio or video information of the passenger.

6. The method of claim 1, wherein the first input is a message received from a remote computing device, and wherein identifying the severity level is based on content of the message identifying why the vehicle needs to be pulled over.

7. The method of claim 1, wherein the first input is a message received from a remote system, and wherein the message identifies the severity level.

8. The method of claim 7, wherein the message further identifies an additional requirement, and wherein performing the search to identify the location further includes confirming that the location meets the additional requirement.

9. The method of claim 1, wherein the first input is a report from a system of the vehicle indicating a fault at that system, and the method further comprises identifying an additional requirement based on a type of the fault, wherein performing the search to identify the location further includes confirming that the location meets the additional requirement.

10. The method of claim 1, wherein the set of requirements identifies a number of permissible lane changes.

11. The method of claim 1, wherein the set of requirements identifies a number of permissible turns.

12. The method of claim 1, wherein the set of requirements identifies whether the vehicle may stop in an intersection.

13. The method of claim 1, wherein performing the search includes requiring that the vehicle continue along a current route for a predetermined period of time before the vehicle reaches the location.

14. The method of claim 1, further comprising performing the search for a predetermined period of time, such that if the location is not identified during the predetermined period of time, repeating the search using an adjusted set of requirements to identify the location.

15. The method of claim 1, wherein performing the search to identify the location is based on whether the vehicle will reach a destination location before reaching any location that meets the set of requirements.

16. The method of claim 15, wherein when the vehicle will reach the destination location before reaching any location that meets the set of requirements, setting the destination location as the location such that the vehicle continues to the destination location.

17. A system for maneuvering a vehicle in an autonomous driving mode, the system comprising one or more processors configured to:
determine that the vehicle needs to pullover based on a first input;
identify a severity level corresponding to the first input;
identify a set of requirements based on the severity level;
perform a search over a map to identify a location for the vehicle to pull over that meets the set of requirements; and
maneuver the vehicle in order to pull over at the location.

18. The system of claim 17, wherein the first input is an input from a passenger of the vehicle, and the one or more processors are further configured to:
identify a first severity level based on the input; and
increase the first severity level to the severity level based on circumstances of the input.

19. The system of claim 17, wherein the first input is a message received from a remote computing device, and wherein the one or more processors are further configured to identify the severity level based on content of the message identifying why the vehicle needs to be pulled over.

20. The system of claim 17, further comprising the vehicle.
